(19) United States
(12) Patent Application Publication
(10) Pub. No.: US 2026/0348286 A1
(43) Pub. Date: Nov. 5, 2026

(54) TURBINE BLADE WITH COVER PLATE STRESS-REDUCTION FEATURE

(71) Applicant: GE Vernova Infrastructure Technology LLC, Greenville, SC (US)

(72) Inventors: Grant Alan Hovey, Greenville, SC (US); Melbourne James Myers, Woodruff, SC (US); William Scott Zemitis, Simpsonville, SC (US)

(21) Appl. No.: 19/195,844

(22) Filed: May 1, 2025

(51) Int. Cl. F01D 5/30; F01D 5/14; F01D 5/16; F01D 5/32; F01D 11/00

(52) U.S. Cl. CPC F01D 5/3007; F01D 5/147; F01D 5/16; F01D 5/3015; F01D 5/323; F01D 11/006; F05D 2250/712; F05D 2260/941; F05D 2260/96

(57) ABSTRACT

A turbine blade includes an airfoil having a suction side, a pressure side opposing the suction side, a leading edge and a trailing edge. A root is coupled to the airfoil. The root includes a shank coupled to a rotor wheel connector by a cover plate. A stress-reducing feature includes a radially inward facing recess extending at least partially through the cover plate at a junction of the cover plate with the rotor wheel connector. A turbine stage and a gas turbine system including the turbine blade are also disclosed.

### TECHNICAL FIELD

The subject matter disclosed herein relates to turbomachines. More particularly, the subject matter disclosed herein relates to turbine blade having a cover plate stress-reduction feature.

### BACKGROUND

Some jet aircraft and simple or combined cycle power plant systems employ a turbine, or so-called a turbomachine, in their configuration and operation. The turbomachines include turbine assemblies (e.g., expansion turbine assemblies) that employ turbine blades with airfoils configured to aerodynamically interact with fluid flows, during operation, to generate energy from these fluid flows as part of power generation. For example, the airfoils may be used to create thrust, to convert kinetic energy to mechanical energy, and/or to convert thermal energy to mechanical energy.

Turbine blades may also include a one-piece root including, among other things, a shank coupled to the airfoil and also connected to a rotor wheel connector by a cover plate. The rotor wheel connector couples the turbine blade to a rotor wheel of the turbine assembly. The airfoil extends radially outwardly from the root, and the cover plate extends generally circumferentially relative to the axially extending rotor wheel connector. In some cases, the trailing edge of the airfoil extends radially over or overhangs (axially or circumferentially), a junction where the cover plate and rotor wheel connector meet. In this situation, during operation, relatively high, transient low cycle fatigue stresses may be created at the junction.

### BRIEF DESCRIPTION

All aspects, examples and features mentioned below can be combined in any technically possible way.

An aspect of the disclosure includes a turbine blade comprising: an airfoil having: a suction side, a pressure side opposing the suction side, a leading edge, a trailing edge; a root coupled to the airfoil, the root including a shank coupled to a rotor wheel connector by a cover plate; and a stress-reducing feature including a radially inward facing recess extending at least partially through the cover plate at a junction of the cover plate with the rotor wheel connector.

Another aspect of the disclosure includes any of the preceding aspects, and the turbine blade includes a second stage blade.

Another aspect of the disclosure includes any of the preceding aspects, and further comprises a fillet connecting the cover plate to the rotor wheel connector, wherein the radially inward facing recess is partially defined in the fillet.

Another aspect of the disclosure includes any of the preceding aspects, and the radially inward facing recess is positioned at the junction of the cover plate with the rotor wheel connector in an aft end, pressure side corner of the root.

Another aspect of the disclosure includes any of the preceding aspects, and the radially inward facing recess is also open in an aft-facing direction.

Another aspect of the disclosure includes any of the preceding aspects, and the radially inward facing recess includes a first arc portion having a first radius of curvature contiguous with a surface of the rotor wheel connector, a second arc portion having a second radius of curvature and contiguous with the first arc portion, and a third arc portion having a third radius of curvature and contiguous with the second arc portion, wherein the first, second and third radii of curvature are different from each other.

Another aspect of the disclosure includes any of the preceding aspects, and the first, second and third radii of curvature are concave.

Another aspect of the disclosure includes any of the preceding aspects, and the first radius of curvature is convex, and the second and third radii of curvature are concave.

Another aspect of the disclosure includes any of the preceding aspects, and the radially inward facing recess extends between 20-80% of an axial depth of the cover plate from an axially outward facing surface thereof in a location apart from an internal fillet between the cover plate and the shank.

Another aspect of the disclosure includes any of the preceding aspects, and the radially inward facing recess includes a slot extending through an axial depth of the cover plate and a closing plate coupled to an axially forward-facing surface of the cover plate to form the radially inward facing recess with the slot.

Another aspect of the disclosure includes a turbine blade stage for a turbine, the turbine blade stage comprising: a plurality of turbine blades including at least one turbine blade having: an airfoil having: a suction side, a pressure side opposing the suction side, a leading edge, a trailing edge; a root coupled to the airfoil, the root including a shank coupled to a rotor wheel connector by a cover plate; and a stress-reducing feature including a radially inward facing recess extending at least partially through the cover plate at a junction of the cover plate with the rotor wheel connector.

Another aspect of the disclosure includes any of the preceding aspects, and the turbine blade stage is a second stage of the turbine.

Another aspect of the disclosure includes any of the preceding aspects, and further comprises a fillet connecting the cover plate to the rotor wheel connector, wherein the radially inward facing recess is partially defined in the fillet.

Another aspect of the disclosure includes any of the preceding aspects, and the radially inward facing recess is positioned at the junction of the cover plate with the rotor wheel connector in an aft end, pressure side corner of the root.

Another aspect of the disclosure includes any of the preceding aspects, and the radially inward facing recess is also open in an aft-facing direction.

Another aspect of the disclosure includes any of the preceding aspects, and the radially inward facing recess includes a first arc portion having a first radius of curvature contiguous with a surface of the rotor wheel connector, a second arc portion having a second radius of curvature and contiguous with the first arc portion, and a third arc portion having a third radius of curvature and contiguous with the second arc portion, wherein the first, second and third radii of curvature are different from each other.

Another aspect of the disclosure includes any of the preceding aspects, and the first, second and third radii of curvature are concave.

Another aspect of the disclosure includes any of the preceding aspects, and the radially inward facing recess extends between 20-80% of an axial depth of the cover plate from an axially outward facing surface thereof in a location apart from an internal fillet between the cover plate and the shank.

Another aspect of the disclosure includes any of the preceding aspects, and the radially inward facing recess includes a slot extending through an axial depth of the cover plate and a closing plate coupled to an axially forward-facing surface of the cover plate to form the radially inward facing recess with the slot.

Another aspect of the disclosure includes a gas turbine system comprising a compressor, a combustor operatively coupled to the compressor, and a turbine assembly operatively coupled to the combustor, wherein the turbine assembly includes the turbine blade stage of any of the preceding turbine blade stage aspects.

Two or more aspects described in this summary section may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a simplified cross-sectional view of an illustrative turbomachine;

FIG. 2 shows a cross-section view of an illustrative turbine assembly with four stages that may be used with the turbomachine in FIG. 1;

FIG. 3 shows a side and rear perspective view of a turbine blade, according to embodiments of the disclosure;

FIG. 4 shows an axial end view of a turbine blade, according to embodiments of the disclosure;

FIG. 5 shows an enlarged side and rear perspective view of a turbine blade, according to embodiments of the disclosure.

FIG. 6 shows an enlarged axial end view of a stress-reducing feature, according to embodiments of the disclosure;

FIG. 7 shows an enlarged bottom (radially outward) view of a stress-reducing feature, according to embodiments of the disclosure;

FIG. 8 shows a schematic view of a stress-reducing feature, according to embodiments of the disclosure;

FIG. 9 shows a schematic view of a stress-reducing feature, according to other embodiments of the disclosure; and

FIG. 10 shows an enlarged bottom (radially outward) view of a stress-reducing feature, according to other embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current technology, it will become necessary to select certain terminology when referring to and describing relevant machine components within a turbomachine. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as the working fluid through the turbine engine or, for example, the flow of air through the combustor or coolant through one of the turbine's component systems. The term “downstream” corresponds to the direction of flow of the fluid, and the term “upstream” refers to the direction opposite to the flow. The terms “forward” and “aft,” without any further specificity, refer to directions, with “forward” referring to the front or compressor end of the engine, and “aft” referring to the rearward or turbine end of the engine.

It is often required to describe parts that are disposed at different radial positions with regard to a center axis. The term “radial” refers to movement or position perpendicular to an axis. For example, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of a gas turbine (GT) system. In the legends used in the drawings, X is an axial direction parallel to an axis of the GT system, Z is a radial direction perpendicular to (or vertically away from) the axis of the GT system, and Y is a circumferential direction perpendicular to (or around) the axis of the GT system.

In addition, several descriptive terms may be used regularly herein, as described below. The terms “first”, “second”, and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described feature or element may or may not be present and that the description includes instances where the feature is present and instances where it is not.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, no intervening elements or layers are present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As noted herein, various aspects of the disclosure are directed toward a turbine blade that includes an airfoil having a suction side, a pressure side opposing the suction side, a leading edge and a trailing edge. A root is coupled to the airfoil. The root includes a shank coupled to a rotor wheel connector by a cover plate. A stress-reducing feature on the cover plate includes a radially inward facing recess extending at least partially through the cover plate at a junction of the cover plate with the rotor wheel connector. A turbine stage and a gas turbine system including the turbine blade are also disclosed. The radially inward facing recess reduces stress at the junction of the cover plate and rotor wheel connector by directing the load around the cover plate location. Since the recess only extends partially through the cover plate, it does not impact leakage at the shank. The stress-reducing feature can be provided during manufacture or during post-use service of the turbine blade. Embodiments of the disclosure also includes a turbine stage and a GT system including the turbine blade.

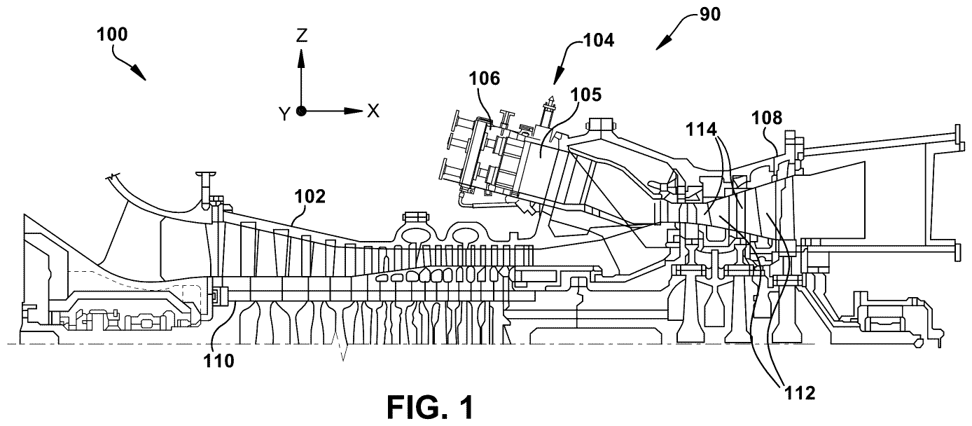

Referring to the drawings, FIG. 1 is a schematic view of an illustrative non-limiting turbomachine 90 in the form of a combustion turbine or gas turbine (GT) system 100 (hereinafter, “GT system 100”). GT system 100 includes a compressor section 102 and one or more combustors 104. Combustor 104 includes a combustion region 105 and a fuel nozzle assembly 106. GT system 100 also includes a turbine assembly 108 and a common compressor/turbine rotor 110 (hereinafter referred to as “rotor 110”).

In one non-limiting embodiment, GT system 100 is a 9HA.02 engine, commercially available from GE Vernova, Cambridge, MA, USA. The present disclosure is not limited to any one particular GT system 100 and may be implanted in connection with other engines including, for example, the other HA, F, B, LM, GT, TM and E-class engine models of GE Vernova, and engine models of other companies. Further, the teachings of the disclosure are not necessarily applicable to only a GT system and may be applied to other types of turbomachines, e.g., steam turbines, jet engines, compressors, etc.

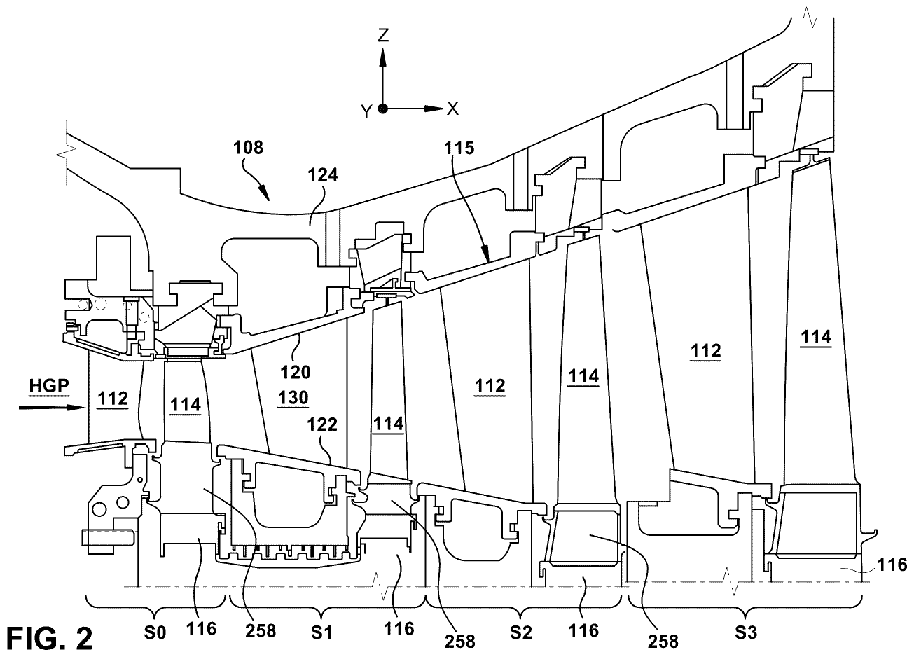

FIG. 2 shows a cross-section view of an illustrative non-limiting portion of turbine assembly 108 with four stages S0-S3 that may be used with GT system 100 in FIG. 1. The four stages, which are referred to as S0, S1, S2, and S3, increase in radial size from stage S0 to stage S3. Stage S0 is the first stage and is the smallest (in a radial direction) of the four stages. Stage S1 is the second stage and is the next stage in an axial direction. Stage S2 is the third stage and is the next stage in an axial direction. Stage S3 is the fourth, last stage and is the largest (in a radial direction). It is to be understood that four stages are shown as one non-limiting example only, and each turbine assembly 108 may have more or less than four stages.

A set of stationary vanes or nozzles 112 cooperate with a set of rotating blades 114 to form each stage S0-S3 of turbine assembly 108 and to define a portion of a flow path through turbine assembly 108. Rotating turbine blades 114 in each set are coupled to a respective rotor wheel 116 that couples them circumferentially to rotor 110 (FIG. 1). That is, a plurality of rotating turbine blades 114 are mechanically coupled in a circumferentially spaced manner to each rotor wheel 116. A static blade section 115 includes the stationary nozzles 112 circumferentially spaced around rotor 110. Each nozzle 112 may include at least one platform (or platform) 120, 122 connected with airfoil 130. In the example shown in FIG. 2, nozzle 112 includes a radially outer platform 120 and a radially inner platform 122. Radially outer platform 120 couples nozzle 112 to a casing 124 of turbine assembly 108.

In operation, air flows through compressor section 102, and compressed air is supplied to combustor 104. Specifically, the compressed air is supplied to fuel nozzle assembly 106 that is integral to combustor 104. Fuel nozzle assembly 106 is in flow communication with combustion region 105. Fuel nozzle assembly 106 is also in flow communication with a fuel source (not shown in FIG. 1) and channels fuel and air to combustion region 105. Combustor 104 ignites and combusts fuel. Combustor 104 is in flow communication with turbine assembly 108 within which gas stream thermal energy is converted to mechanical rotational energy. Turbine assembly 108 is rotatably coupled to and drives rotor 110. Compressor section 102 also is rotatably coupled to rotor 110. In the illustrative embodiment, there is a plurality of combustors 104 and fuel nozzle assemblies 106. In the following discussion, unless otherwise indicated, only one of each component will be discussed. At least one end of rotating rotor 110 may extend axially away from turbine assembly 108 (or compressor section 102) and may be attached to a load or machinery (not shown), such as, but not limited to, a generator, a load compressor, and/or another turbine.

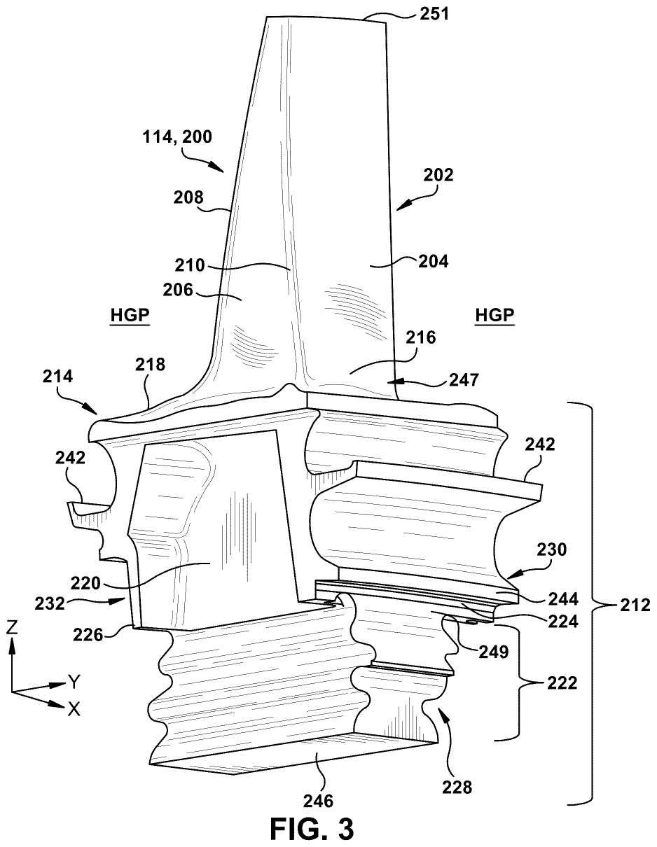

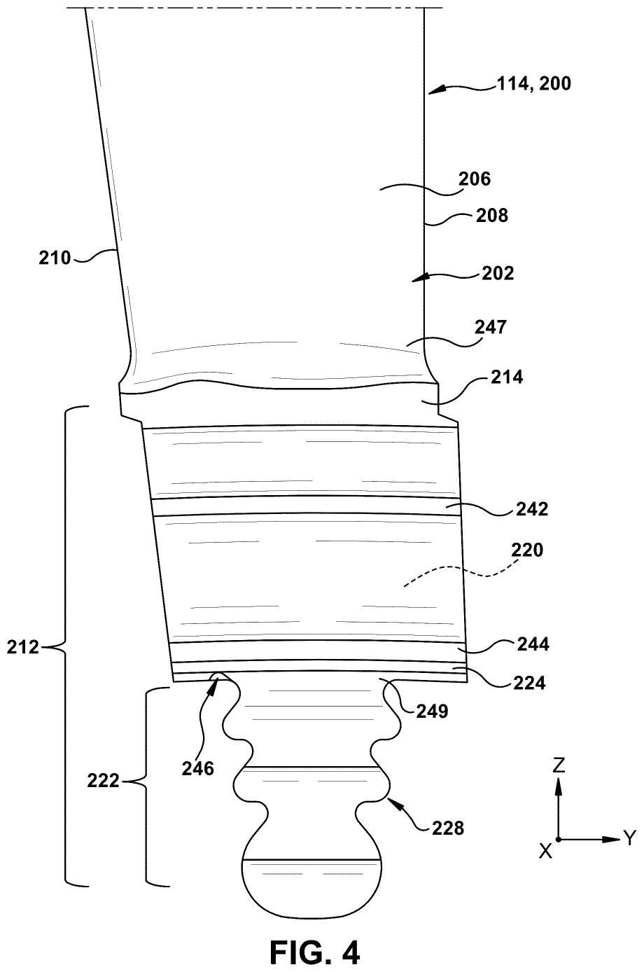

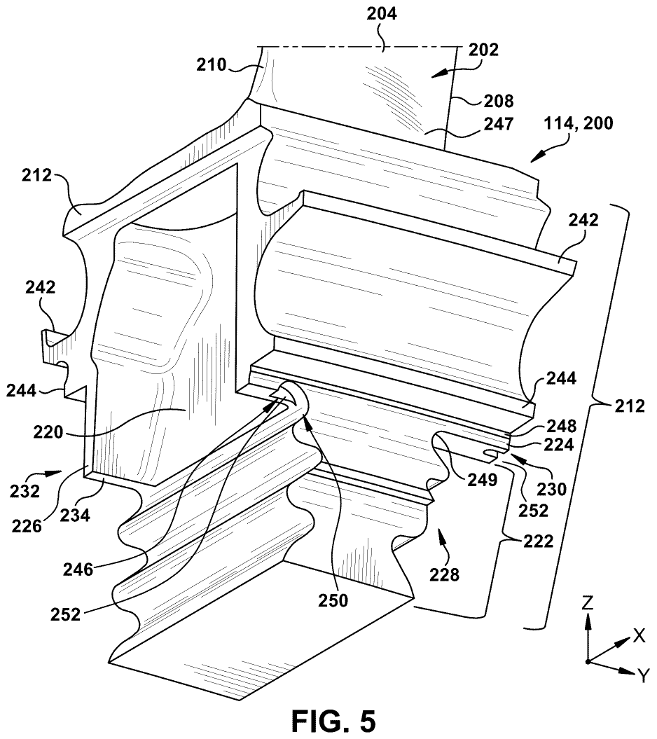

FIG. 3 shows a side and rear perspective view, FIG. 4 shows an axial end view, and FIG. 5 shows an enlarged side and rear perspective view of a turbine blade 200 according to embodiments of the disclosure. Turbine blade 200 (hereafter “blade 200”) can be used as any turbine blade 114 (FIG. 2) in GT system 100. The turbine blade is a rotatable (dynamic) blade, which, as shown in FIG. 2, is part of a set of turbine blades circumferentially dispersed about a rotor in a stage of a turbine (e.g., one of stages S0-S3 of turbine assembly 108). That is, during operation of turbine assembly 108, as a working fluid (e.g., gas or steam) is directed along a hot gas path (HGP) and across the blades' airfoils, the turbine blades 114, 200 will initiate rotation of rotor 110 (FIG. 1) and rotate about an axis defined by rotor 110 (FIG. 1). It is understood that blade 200 is configured to couple (mechanically couple via fasteners, welds, slot/grooves, etc.) with a plurality of similar or distinct blades (e.g., blades 200 or other blades) to form a set of blades in a stage of turbine assembly 108 (e.g., second stage S1 in FIG. 2).

With reference to FIG. 3, turbine blade 200 can include an airfoil 202 having a suction side 204 and a pressure side 206 opposing suction side 204. Blade 200 can also include a leading edge 208 spanning between pressure side 206 and suction side 204, and a trailing edge 210 opposing leading edge 208 and spanning between pressure side 206 and suction side 204.

Leading edge 208 is defined as an edge or line at which combustion flow diverges to pass over or by pressure side 206 or suction side 204.

As shown, blade 200 can also include a root 212 coupled to airfoil 202, i.e., at a radial inner end 247 of airfoil 202, and a tip end 251 on an opposite end of airfoil 202. In FIG. 3, tip end 251 is shown without a tip shroud. Root 212 may include a platform 214 that forms part of a hot gas path (HGP) with nozzles 112 (FIG. 2). Platform 214 can be connected with airfoil 202 along suction side 204, pressure side 206, trailing edge 210 and leading edge 208. In various embodiments, blade 200 includes a fillet 216 proximate radial inner end 247 of airfoil 202. Fillet 216 connects airfoil 202 and platform 214 (e.g., at a surface 218 of platform 214). Fillet 216 can include an additively manufactured or cast curved transitional surface, or a weld or braze fillet, which may be formed via conventional MIG welding, TIG welding, brazing, etc. Platform 214 is intended to be located radially inboard of airfoil 202 and be formed in any complementary configuration to the rest of root 212.

Root 212 also includes a shank 220 coupled to a rotor wheel connector 222 by one or more cover plates 224, 226. Rotor wheel connector 222 can include any now known or later developed structure configured to couple blade 200 with rotor wheel 116 (FIG. 2) of rotor 110 (FIG. 1). In the non-limiting example shown, rotor wheel connector 222 includes a dovetail structure 228 configured to fit into a mating slot (not shown) in rotor wheel 116 (FIG. 2) and to mate with adjacent components of other blades 200. Rotor wheel connector 222 extends generally in an axial direction, i.e., X direction. Shank 220 can take any now known or later developed structure such as but not limited to a block member for spanning a distance between airfoil 202 and rotor wheel connector 222 and having any variety of cooling passages (not shown) therein. A cover plate 224 may couple shank 220 with rotor wheel connector 222 at an aft end 230 of shank 220. Another cover plate 226 may couple shank 220 with rotor wheel connector 222 at a forward end 232 of shank 220.

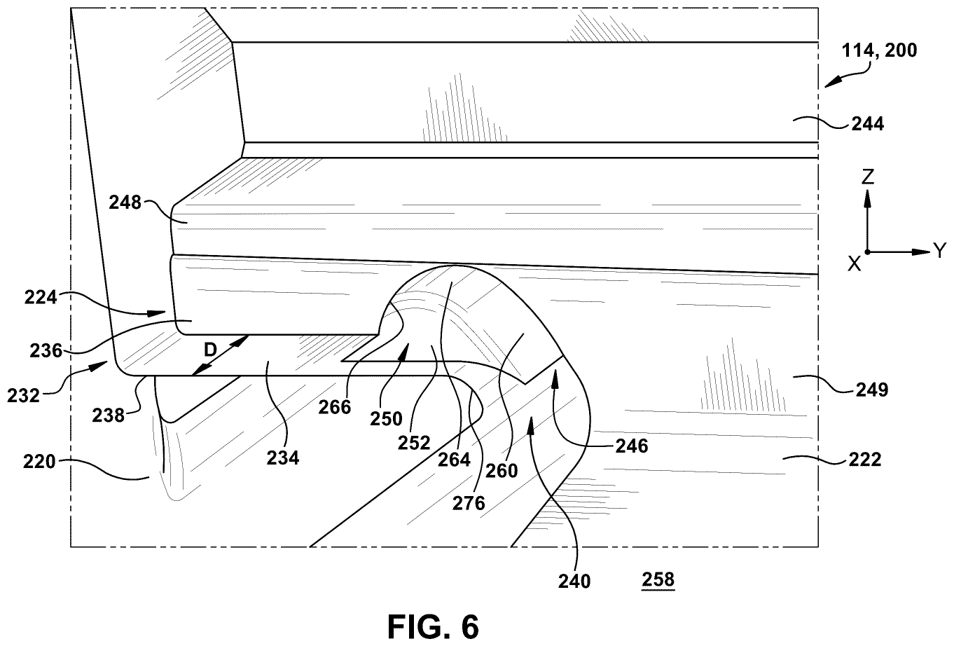

Cover plates 224, 226 may extend longitudinally generally circumferentially (in Y direction) at aft and fore ends 230, 232, respectively, of shank 220 to couple shank 220 with rotor wheel connector 222. Cover plates 224, 226 have radially inward facing surfaces 234 (FIG. 5) and axially outward facing surfaces 236 (FIG. 6). Axial outward facing surface 236 faces aft for cover plate 224 at aft end 230 of shank 220 (generally rightward in FIG. 3) and faces forward for cover plate 226 at forward end 232 of shank 220 (generally leftward in FIG. 3). Cover plates 224, 226 are integral with surrounding structure to, for example, decrease overall leakage, reduce complexity for assembly/disassembly, and reduce costs. Cover plates 224, 226 function to create a pressure barrier to maintain high pressure in the area of shank 220 under platform 214 so colder air always outflows from platform 214 towards the HGP, preventing hot gases from ingesting to rotor wheel 116 (FIG. 2).

Blade 200 may also include any variety of seals such as angel wings 242 and/or near flowpath seal (NFS) lands 244 that mate with similar structures of adjacent blades 200 to prevent combustion gas flow from the hot gas path (HGP) into a wheel space 258 (FIG. 2) between adjacent blades 200, and/or coolant from wheel space 258 (FIG. 2) into the HGP. As shown in FIGS. 5-8, NFS lands 244 couple to cover plates 224, 226 via a fillet 248. Blade 200 may also include a fillet 249 connecting cover plate 224 to rotor wheel connector 222. Fillets 248, 249 can include an additively manufactured or cast curved transitional surface, or a weld or braze fillet, which may be formed via conventional MIG welding, TIG welding, brazing, etc.

With reference to FIG. 4, it is observed that trailing edge 210 of airfoil 202 may extend over or overhang cover plate 224, which, in the example shown, is at aft end 230 of shank 220. Consequently, a junction 246 where cover plate 224 and rotor wheel connector 222 meet may experience relatively high, transient low cycle fatigue stresses. As shown in and further described relative to FIGS. 5-8, turbine blade 200, in accordance with various embodiments of the disclosure, also includes a stress-reducing feature 250 at junction 246 to reduce or eliminate the stress. It will be recognized that a stress-reducing feature 250 may be located at any junction between cover plates 224, 226 with rotor wheel connector 222, and the location and description of cover plate 224 at aft end 230 of shank 220 is only illustrative.

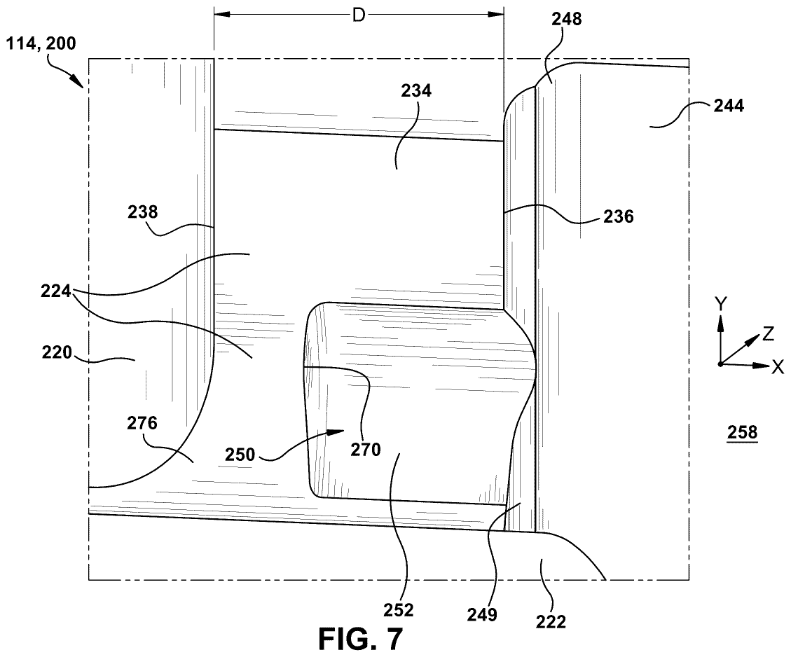

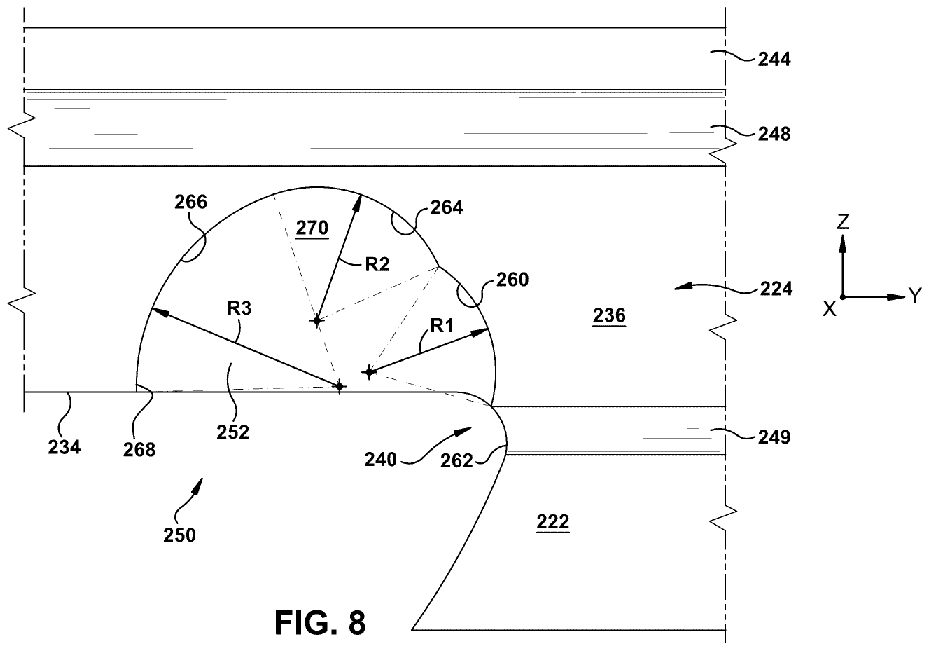

FIG. 6 shows an enlarged axial end view, FIG. 7 shows an enlarged bottom (radially outward) view, and FIG. 8 shows a schematic view of stress-reducing feature 250, according to various embodiments of the disclosure. Stress-reducing feature 250 may include a radially inward facing recess 252 (hereafter “recess 252”) extending at least partially through cover plate 224 at junction 246 of cover plate 224 with rotor wheel connector 222. “Facing radially inward” means recess 252 is open toward rotor 110, i.e., facing inward in a Z-direction toward rotor 110. Recess 252 may also be open in an aft-facing direction, i.e., facing aftward in an X-direction (e.g., recess 252 along aft end 230 of shank 220, as shown in FIG. 5). As shown in FIG. 7, recess 252 may extend partially through cover plate 224 in an axial sense, i.e., in X direction, so that fluid cannot pass through recess 252 from a wheel space 258 (see FIGS. 2, 6 and 8) between adjacent blades 200 to an area adjacent shank 220. In the example shown, for example in FIG. 3, recess 252 is positioned at junction 246 of cover plate 224 with rotor wheel connector 222 in forward end 232, pressure side 206 corner of root 212. As noted, it can be used in other junctions 246 of cover plate 224 or 226 and rotor wheel connector 222.

In operation, radially inward facing recess 252 (hereafter “recess 252”) removes material through which stress would normally be transmitted through the abrupt change in width from cover plate 224 to rotor wheel connector 222, thereby directing the stress into other regions of cover plate 224, fillet 248, rotor wheel connector 222 and perhaps NFS land 244. Recess 252 can have any shape configured to reduce the desired amount of stress. In some embodiments, as shown in FIG. 6, recess 252 may be partially defined in fillet 249, e.g., in terms of radial depth, and may extend radially outward but typically does not reach into fillet 248 between cover plate 224 and NFS land 244.

As shown in FIG. 8, in some embodiments, recess 252 may include a number of contiguous arc portions. In one example, recess 252 includes three arc portions. More particularly, recess 252 may include a first arc portion 260 having a first radius of curvature R1 contiguous with a surface 262 of rotor wheel connector 222. Surface 262 of rotor wheel connector 222 may face in circumferential (Y) direction and may be part of rotor wheel connector 222 and perhaps part of fillet 249 between connector 222 and cover plate 224. Recess 252 may also include a second arc portion 264 having a second radius of curvature R2 and contiguous with first arc portion 260. Recess 252 may also include a third arc portion 266 having a third radius of curvature R3 and contiguous with second arc portion 264. An opposing end 268 of third arc portion 266 from second arc portion 264 terminates at radial inward facing surface 234 of cover plate 224.

First, second and third radii of curvature R1-R3 may be different from each other. The radii of curvature R1-R3 may vary and scale depending on, among other factors, the size of turbine blade 200 and parts thereof and/or the stresses observed. In some embodiments, radius of curvature R1 may be in a range of 12.45-17.5 millimeters (mm) (~0.49-0.69 inches (in.)), and in other embodiments may be approximately 14.99 mm (~0.59 in.). In some embodiments, radius of curvature R2 may be in a range of 2.54-5.08 mm (~0.10-0.20 in.), and in other embodiments may be approximately 3.81 mm (~0.15 in.). In some embodiments, radius of curvature R3 may be in a range of 3.30-5.84 mm (~0.13-0.23 in.), and in other embodiments may be approximately 4.57 mm (~0.18 in.). As noted, other dimensions for first, second and third radii of curvature are also possible, for example, depending on the size of turbine blade 200, parts thereof, or stresses involved. Arc portions 260, 264, 266 are tangent to one another, but first arc portion 260 is not tangent to surface 262 of rotor wheel connector 222. Arc portions 260, 264, 266 may gradually transition to a sidewall 270 of recess 252, e.g., with an arcuate transitional surface (not separately labeled). In other embodiments, recess 252 may include a single arc portion, two arc portions, or more than three arc portions.

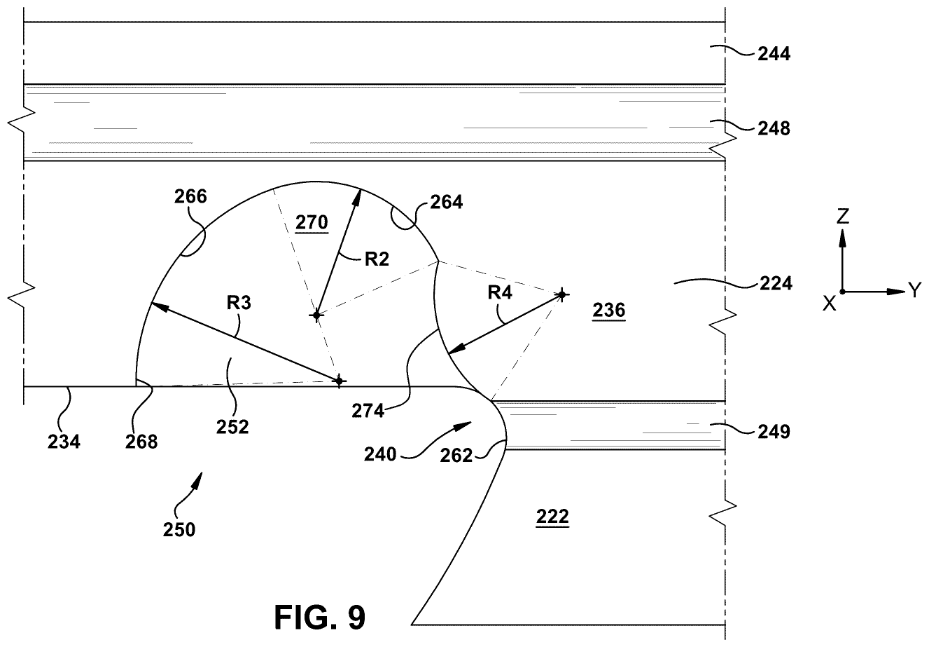

In some embodiments, as shown in FIGS. 6-8, arc portions 260, 264, 266 are all concave. In this case, recess 252 has an appearance of a generally concave opening. FIG. 9 shows a schematic view of a stress-reducing feature, according to other embodiments of the disclosure. For example, FIG. 9 shows some alternative embodiments in which at least one of arc portions 260, 264, 266 is convex. In the example shown in FIG. 9, a different first arc portion 274 has a fourth radius of curvature R4 contiguous with surface 262 of rotor wheel connector 222, i.e., connector 222. In this example, first arc portion 274 having fourth radius of curvature R4 is convex, while second and third arc portions 264, 266 are concave. Second arc portion 264 having second radius of curvature R2 that is concave is contiguous with first arc portion 274 that is convex. Fourth radius of curvature R4 may be the same as first radius of curvature R1 (FIG. 8), but in the opposite direction. Second and third arc portions 264, 266 may have radii of curvature R2, R3 as stated previously herein relative to FIG. 8. Other dimensions for second, third and fourth radii of curvature are also possible.

As shown in FIGS. 3-8, root 212 can be a one-piece member, which can be manufactured using any appropriate manufacturing process such as but not limited to casting and/or additive manufacture. Cover plate 224 may have an axial depth D between axially outward facing surface 236 and axially inward facing surface 238. Recess 252 does not extend axially through an entirety of cover plate 224. In some embodiments, as shown in FIGS. 6 and 7, recess 252 may extend between 50-65% of axial depth D of cover plate 224 from axially outward facing surface 236 to sidewall 270 of recess 252 in a location apart from an internal fillet 276 between cover plate 224 to shank 220. That is, where no internal fillet 276 exists, recess 252 may extend between 50-65% of axial depth D of cover plate 224 from axially outward facing surface 236 to sidewall 270 of recess 252. Internal fillet 276 can include an additively manufactured or cast curved transitional surface, or a weld or braze fillet, which may be formed via conventional MIG welding, TIG welding, brazing, etc. The axial depth of recess 252 may also vary or scale depending on, among other factors, the size of turbine blade 200 and parts thereof and/or the stresses observed. Hence, in other embodiments, as also shown in FIG. 7, recess 252 may extend between 20-80% of an axial depth D of cover plate 224 from axially outward facing surface 236 to sidewall 270 thereof in a location apart from an internal fillet 276 between cover plate 224 to shank 220.

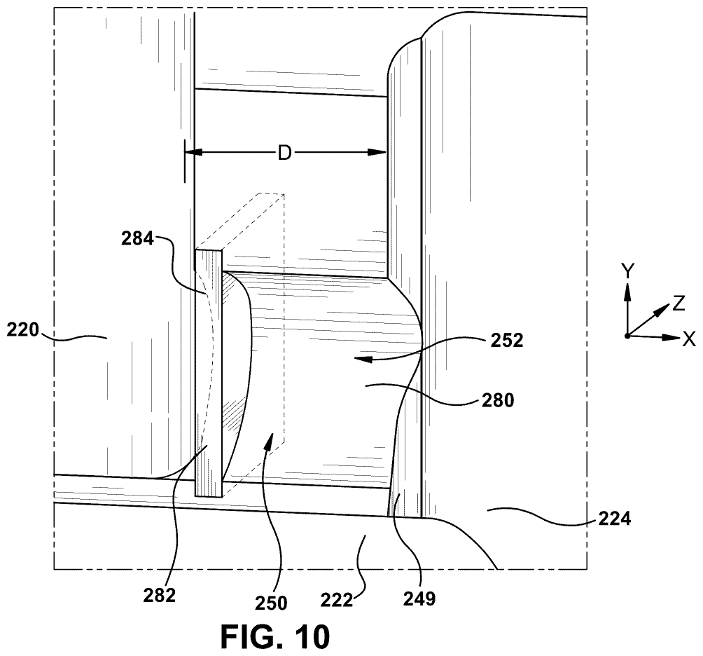

FIG. 10 shows an enlarged bottom (radially outward) view of stress-reducing feature 250 according to other embodiments of the disclosure. In FIG. 10, recess 252 includes a slot 280 extending through axial depth D of cover plate 224 and a closing plate 282 coupled to an axially forward-facing surface 284 of cover plate 224 to form recess 252 with slot 280. Here, integral sidewall 270 (FIGS. 6-8) is removed and replaced with closing plate 282. Closing plate 282 may be coupled to surface 284 in any now known or later developed manner, e.g., welding, brazing, etc. This arrangement may be advantageous for retrofitting a turbine blade 200 with stress reducing feature 250 and where formation of a partial axial depth D recess 252 in an already existing cover plate 224 is impossible or impractical.

With reference again to FIGS. 2 and 3, in various embodiments, blade 200 can function as a first stage (S0) blade, a second stage (S1) blade, a third stage (S2) blade, or a fourth stage (S3) blade. In some embodiments, blade 200 is a second stage (S0) blade. In various embodiments, turbine assembly 108 can include a set of blades 200 in only the first stage (S0) of turbine assembly 108, or in only second stage (S1) of turbine assembly 108, or in only third stage (S2) of turbine assembly 108, or in only fourth stage (S3) of turbine assembly 108.

Some embodiments of the disclosure may also include, as shown in FIG. 2, a turbine blade stage S0-S3 for turbine assembly 108 including a plurality of turbine blades (114) including at least one blade 200 (FIGS. 3-10), as described herein.

Some embodiments of the disclosure also include, as shown in FIG. 1, GT system 100 including compressor section 102, one or more combustors 104 operatively coupled to compressor 102, and turbine assembly 108 operatively coupled to the one or more combustors 104. Turbine assembly 108 (FIGS. 1-2) includes a turbine blade stage S0-S3 including at least one turbine blade 200, as described herein.

Embodiments of the disclosure provide various technical and commercial advantages, examples of which are discussed herein. The stress-reducing feature including the radially inward facing recess reduces stress at the junction of the cover plate and rotor wheel connector by directing the load around the cover plate location. Since the recess may only extend partially through the cover plate or is otherwise sealed, it does not impact leakage at the shank. The stress-reducing feature can be provided during manufacture or during post-use service of the turbine blade. The teachings of the present disclosure are not limited to any one particular turbomachine, engine, turbine, jet engine, power generation system or other system, and may be used with turbomachines such as aircraft systems, power generation systems (e.g., simple cycle, combined cycle), and/or other systems (e.g., nuclear reactor). Additionally, the stress-reducing feature of the present disclosure may be used for turbine blades for other systems not described herein that may benefit from the increased stress relief described herein.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” as applied to a particular value of a range applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed.

The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and its practical application and to enable others of ordinary skill in the art to understand the disclosure such that various modifications as are suited to a particular use may be further contemplated.

1. A turbine blade comprising:
an airfoil having: a suction side, a pressure side opposing the suction side, a leading edge, and a trailing edge;
a root coupled to the airfoil, the root including a shank coupled to a rotor wheel connector by a cover plate;
a stress-reducing feature including a radially inward facing recess extending at least partially through the cover plate at a junction of the cover plate with the rotor wheel connector; and
a fillet connecting the cover plate to the rotor wheel connector, wherein the radially inward facing recess is partially defined in the fillet.

2. The turbine blade of claim 1, wherein the turbine blade includes a second stage blade.

3. (canceled)

4. The turbine blade of claim 1, wherein the radially inward facing recess is positioned at the junction of the cover plate with the rotor wheel connector in an aft end, pressure side corner of the root.

5. The turbine blade of claim 1, wherein the radially inward facing recess is also open in an aft-facing direction.

6. The turbine blade of claim 1, wherein the radially inward facing recess includes a first arc portion having a first radius of curvature contiguous with a surface of the rotor wheel connector, a second arc portion having a second radius of curvature and contiguous with the first arc portion, and a third arc portion having a third radius of curvature and contiguous with the second arc portion, wherein the first, second and third radii of curvature are different from each other.

7. The turbine blade of claim 6, wherein the first, second and third radii of curvature are concave.

8. The turbine blade of claim 6, wherein the first radius of curvature is convex, and the second and third radii of curvature are concave.

9. The turbine blade of claim 1, wherein the radially inward facing recess extends between 20-80% of an axial depth of the cover plate from an axially outward facing surface thereof in a location apart from an internal fillet between the cover plate and the shank.

10. The turbine blade of claim 1, wherein the radially inward facing recess includes a slot extending through an axial depth of the cover plate and a closing plate coupled to an axially forward-facing surface of the cover plate to form the radially inward facing recess with the slot.

11. A turbine blade stage for a turbine, the turbine blade stage comprising:
a plurality of turbine blades including at least one turbine blade having: an airfoil having: a suction side, a pressure side opposing the suction side, a leading edge, and a trailing edge;
a root coupled to the airfoil, the root including a shank coupled to a rotor wheel connector by a cover plate;
a stress-reducing feature including a radially inward facing recess extending at least partially through the cover plate at a junction of the cover plate with the rotor wheel connector; and
a fillet connecting the cover plate to the rotor wheel connector, wherein the radially inward facing recess is partially defined in the fillet.

12. The turbine blade stage of claim 11, wherein the turbine blade stage is a second stage of the turbine.

13. (canceled)

14. The turbine blade stage of claim 11, wherein the radially inward facing recess is positioned at the junction of the cover plate with the rotor wheel connector in an aft end, pressure side corner of the root.

15. The turbine blade stage of claim 11, wherein the radially inward facing recess is also open in an aft-facing direction.

16. The turbine blade stage of claim 11, wherein the radially inward facing recess includes a first arc portion having a first radius of curvature contiguous with a surface of the rotor wheel connector, a second arc portion having a second radius of curvature and contiguous with the first arc portion, and a third arc portion having a third radius of curvature and contiguous with the second arc portion, wherein the first, second and third radii of curvature are different from each other.

17. The turbine blade stage of claim 16, wherein the first, second and third radii of curvature are concave.

18. The turbine blade stage of claim 11, wherein the radially inward facing recess extends between 20-80% of an axial depth of the cover plate from an axially outward facing surface thereof in a location apart from an internal fillet between the cover plate and the shank.

19. The turbine blade stage of claim 11, wherein the radially inward facing recess includes a slot extending through an axial depth of the cover plate and a closing plate coupled to an axially forward-facing surface of the cover plate to form the radially inward facing recess with the slot.

20. A gas turbine system comprising a compressor, a combustor operatively coupled to the compressor, and a turbine operatively coupled to the combustor, wherein the turbine includes the turbine blade stage of claim 11.
